(19) United States
(12) Patent Application Publication
(10) Pub. No.: US 2004/0007117 A1
(43) Pub. Date: Jan. 15, 2004

(54) PH musical instrument case/stand

(76) Inventor: Paul Naylor Howard SR., Cape Canaveral, FL (US)

Correspondence Address: Paul Naylor Howard Sr., 8719 Lantana Ct., Cape Canaveral, FL, 32920, US

(21) Appl. No.: 10/191,215

(22) Filed: Jul. 9, 2002

(51) Int. Cl. G10D 3/00

(52) U.S. Cl. 84/327

(57) ABSTRACT

The PH Musical Instrument Case/Stand to carry and hold musical instrument. The case/stand is a new and very needed concept in holding and carrying the musical instrument with one (1) unit. Page 1 show the case/stand 1a the inside of the case/stand with the compartment 1a,2a,4a show the side view which is actually the case/stand setup to hold the musical instrument. Page 3 show how the case/stand can be made to carry and hold more than one (′1) instrument. Page 5 show the case/stand with the holder #4a held on the case with a locking hinge a different concept with each case/stand being custom made the customer can have their case/stand made either way. Page 6 show the larger case/stand for larger instrument like saxophones , string instruments. Page 7 show the hinge that is needed to remove the top of the case only in one (1) positions for security reasons. The string case/stands can be made in two (2) ways page 6 with the instrument holders on the case top page 7 the top being removed and the bottom of the case the holder.

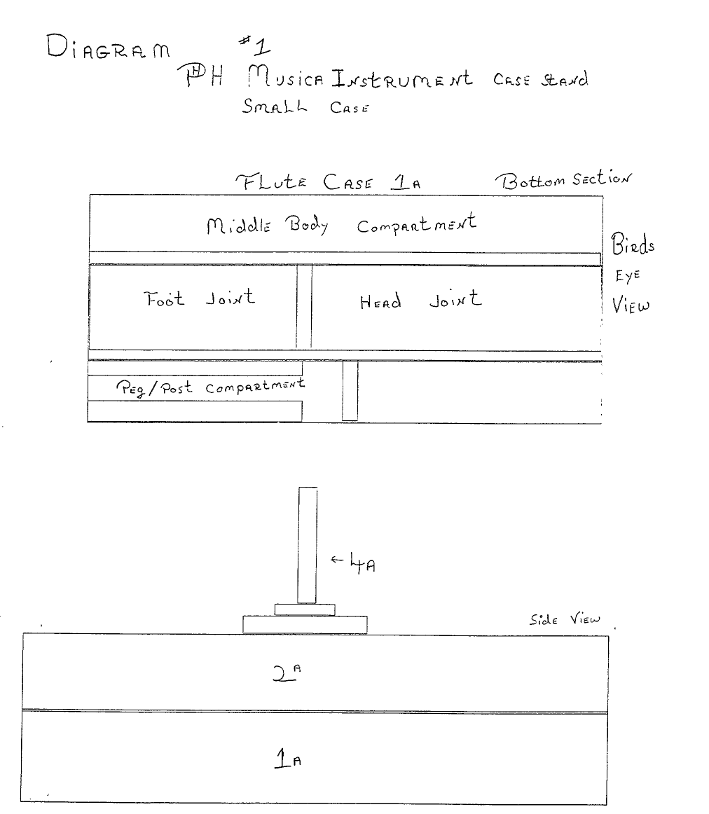

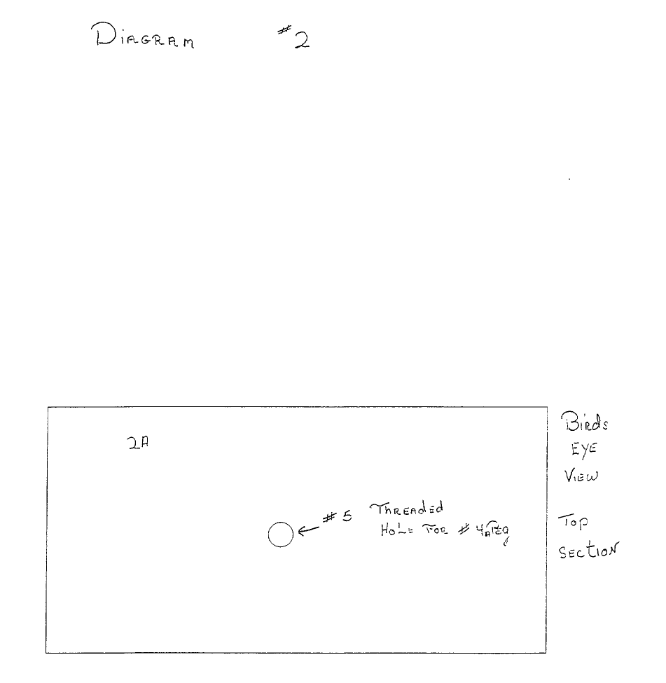

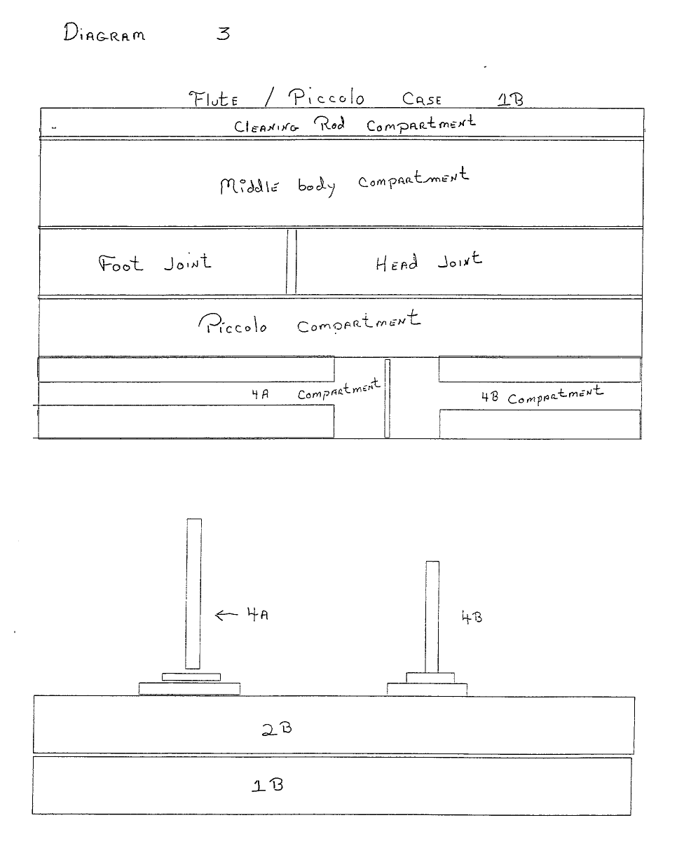

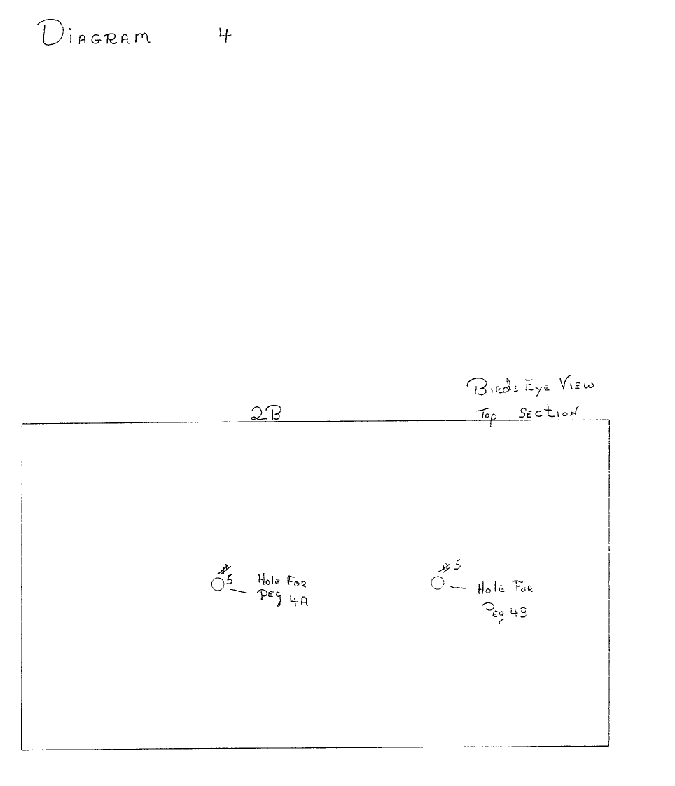

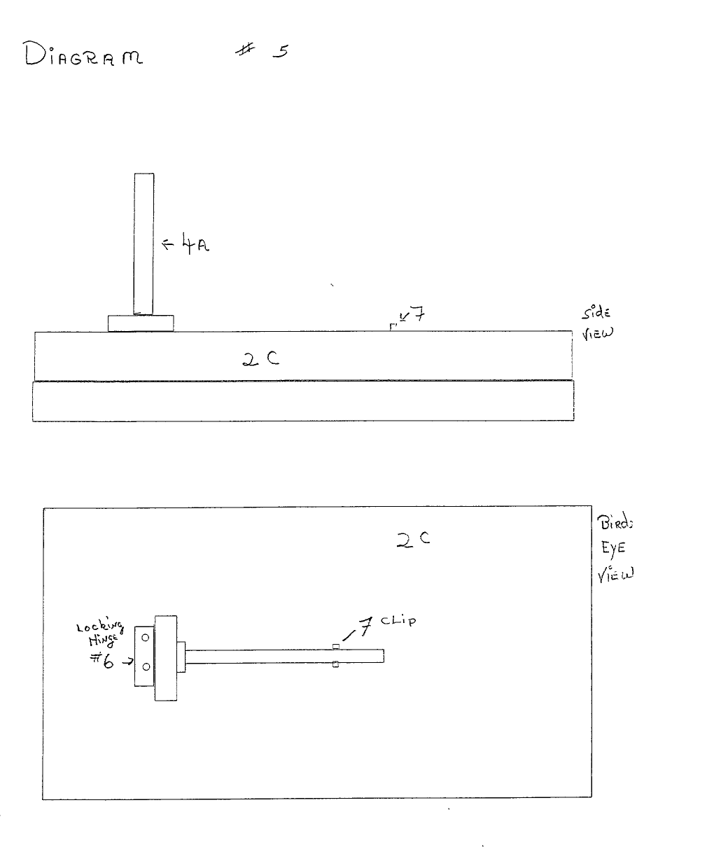

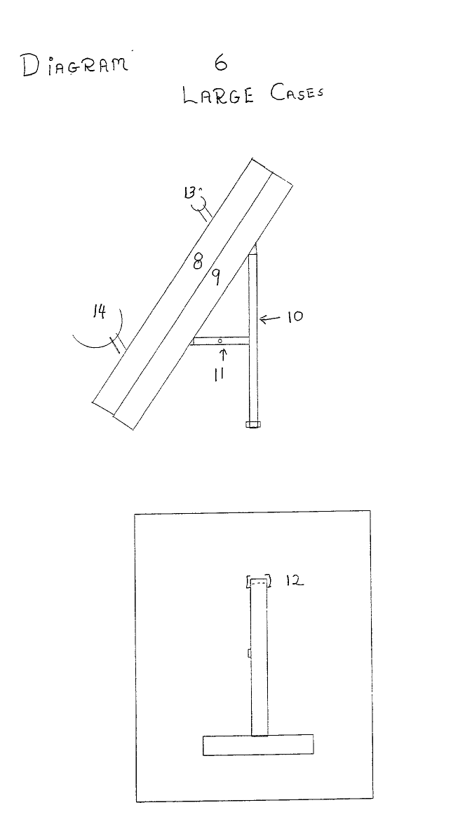

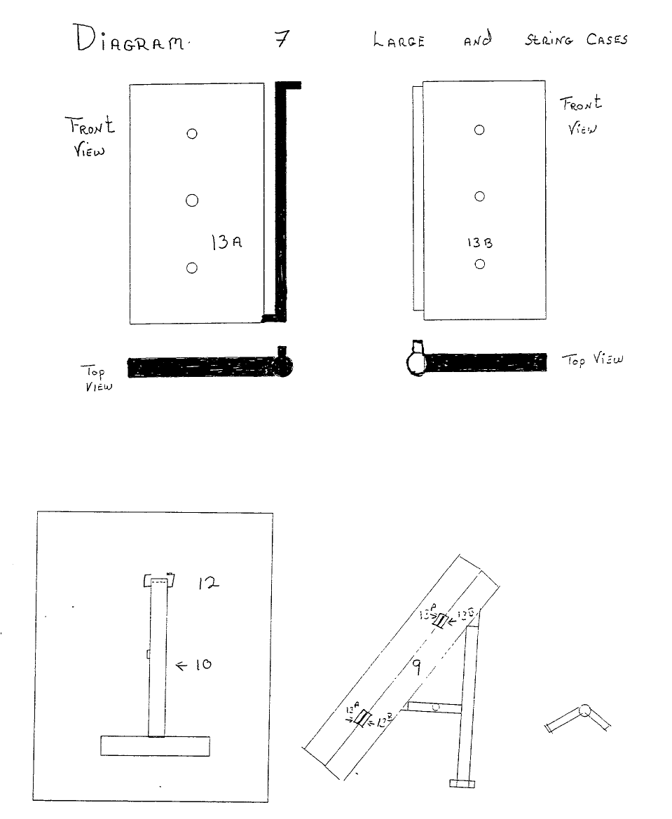

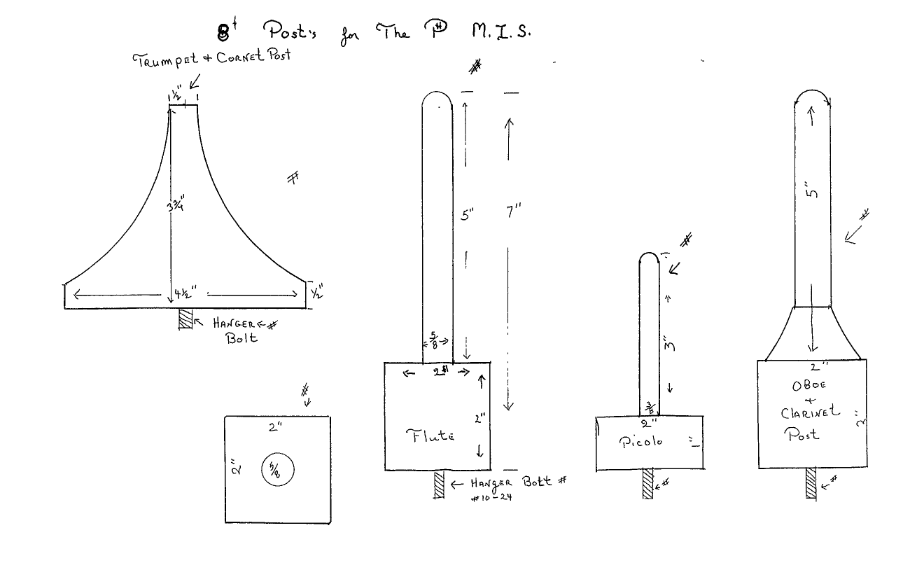

### CROSS-REFERENCE

P P A ser. No. 60/121,154 Filing Date Feb. 22, 1999

### FEDERALLY SPONSORED RESEARCH

Not Applicable

### SEQUENCE LISTING OR PROGRAM

Not Applicable

### BACKGROUND OF INVENTION—FIELD OF INVENTION

This invention relates to musical instruments cases and stands, specifically an improved method of transporting and holding them.

### BACKGROUND OF THE INVENTION—DISCUSSION OF PRIOR ART

All cases and stands up till now have been made as separate item's. This invention combines the case and the stand into one (1) unit. The disadvantageous of the old system's is time , space and the number of item's the musician/student have to carry and handle.

### OBJECTS AND ADVANTAGES

Accordingly, several objects and advantages of my invention are:

(A) Convenience: Less equipment needs to be handle and carried which takes up less space.

(B) Better protection for the instruments.

There are three (3) types of case/stands that this invention covers.

(1) The smaller woodwind instruments

(2) The larger woodwinds and brass

(3) The guitars and other string instruments

The first is a case/stand designed for smaller woodwind “flute family, clarinet, oboe,” Which is made to mount a peg/post on the case to hold the instrument with an extra compartment in the case to carry the peg/post in. Or a peg/post hinged on the case. The seconded (2^{nd}) & third (3^{rd}) case/stands is for the larger instruments which can be added to old cases or build on new cases as a one piece unit . Further objects and advantages of the invention will become apparent from a consideration of the drawings and ensuing discription.

### DISCRIPTION OF INVENTION

(1) The small instrument case/stand. The case/stands shown in the following diagrams are for the flute THE SAME CONCEPT IS USED ON ALL SMALL WOODWIND CASE/STANDS. *Diagram page # 1

This consists of the bottom section (1a) which holds the instrument and peg/post when in transport or stored away. And the side view of the case/stand with the peg/post (4a) on the top section (2a).

Diagram page # 2

This is the top of the case/stand (2a) with the threaded hole (5) to receive peg/post #(4a)

Diagram page #3

This is a two (2) instrument case/stand (1b) which also consists of two (2) peg/post Flute/clarinet peg/post (4a) and Piccolo peg/post (4b) a side view of a complete Case/stand.

Diagram page #4

This is the top view of (2b) case/stand with two (2) threaded holes to receive peg/post (4a & 4b)

Diagram page #5

This shows a hinged peg/post with a locking hinge for either new cases or a add on to A old case.

### DISCRIPTION OF INVENTION

Continued

(2) The Large Instrument case/stand:

Diagram page #6

Shows the side view and back view of a large case/stand which can be use for a sax or Guitar #10 & 11 are the back folding legs of the case/stand #13 & 14 are the folding arms which hold the instrument. #12 is the hinge that holds the legs to the case/stand

Diagram page # 7

This is a different concept of the large case/stand (#13a & #13b) are a hinge designed to come a part at only one(1) position so when you open the case/stand to that position it can be removed from the bottom part of the case/stand and the bottom part becomes the holder for the instrument.

### SUMMARY

My invention is to help the musician/student carry and store their instrument in a safer manner. Having work for years as a musical instrument repair tech. I have seen many damaged instruments which could have been avoidable. This invention will help avoid lot of these misshapes.

| Number | Part Name |
|---|---|
| 1A. | Bottom section of case for one (1) instrument |
| 1B. | Bottom section of case for two (2) instruments |
| 2A. | Top section of case for one (1) instrument |
| 2B. | Top section of case for two (2) instruments |
| 2C. | Top section for hinged post case |
| 4A. | Peg/Post to hold flute |
| 4B. | Peg/Post to hold piccolo |
| 5. | Threaded hole to hold peg/post |
| 6. | Locking hinge |
| 7. | Clip to hold peg/post down |
| 8. | Top section for larger cases “guitars,saxophones,etc.” |
| 9. | Bottom sections of larger cases |
| 10. | Leg |
| 11. | Folding arm |
| 12. | Hinges |
| 13. | Upper arm to hold instrument |
| 13A&B. | New type of inter locking hinge |
| 14. | Lower arm to hold instrument |
| 15. | Trumpet/Comet peg/post |
| 16. | Hanger Bolt |
| 17. | Clarinet/Oboe peg/post |

1. The PH Musical Instrument Case/Stands have many needed features that musical instrument cases and stands do not have today. It combines the case and stand into one unit saving space. The most important feature of the PH case/stand is the protection it gives to the particular musical instrument. I have been an musical instrument repair tech for 40 yrs and have seen the damage instrument that are not stored properly or left laying around not on a stand can happen. Many musicians entertain outside in the open air. The PH Case/Stand for the guitar and larger instruments with my new hinge (#13a&13b) on diagram page 7 will give the most protection possible from the elements and still be handy to get to. This case/stand (diagram page 7) can be made for all instrument that are not taken apart to put in the case. seeing that all case/stands are custom made the small instrument case/stand can be made to hold the instrument in one(1) piece with the leg setup & hinged with the #13a&13b hinge system 1 see diagram page # 7 each and every PH case/stand is custom made for each musical instrument even custom made instruments. The next part of the PH Case/Stand is the convenience (laborsaving) ‘ time and space saving. Instead of having two(2) or more peaces of equipment the entertainer can do away with the un needed equipment. The Case/Stand can also be made to hold two(2) instruments diagram page # 3 which will save more space . The diagram page # 3 shows the small case/stands but the large case/stands can be made to hold two(2) instruments.
